(19) United States
(12) Patent Application Publication
(10) Pub. No.: US 2025/0220071 A1
(43) Pub. Date: Jul. 3, 2025

(54) LOAD PROCESSING METHOD, ELECTRONIC DEVICE, AND STORAGE MEDIUM

(71) Applicant: Beijing Zitiao Network Technology Co., Ltd., Beijing (CN)

(72) Inventor: Qiang LV, Beijing (CN)

(21) Appl. No.: 18/936,246

(22) Filed: Nov. 4, 2024

(30) Foreign Application Priority Data
Jan. 2, 2024 (CN) 202410001953.3

(51) Int. Cl. H04L 67/1008; H04L 43/16; H04L 67/1012

(52) U.S. Cl. CPC H04L 67/1008; H04L 43/16; H04L 67/1012

(57) ABSTRACT

The present disclosure relates to a load processing method, an electronic device and a storage medium. The method includes: obtaining a current load rate of a target server, in response to that the load rate is greater than a first threshold, performing a de-accessing processing on an accessing party accessed to the target server, and in response to that the load rate is not greater than the first threshold, stopping the de-accessing, in which the de-accessing processing is used to reduce a volume of the accessing party accessed to the target server.

### CROSS-REFERENCE TO RELATED APPLICATIONS

This application claims priority from China Patent Application No.202410001953.3 filed on Jan. 2, 2024, and the disclosure of the above-mentioned China Patent Application is hereby incorporated in its entirety as a part of this application.

### TECHNICAL FIELD

The present disclosure relates to the field of communication technology, and in particular, to a load processing method, a load processing apparatus, an electronic device, and a storage medium.

### BACKGROUND

In a real-time communication system, a cluster of a large number of servers is usually required to handle the real-time communication of a large number of users. When a large number of users need to access, the real-time communication system generally selects a server with a low load rate for access to achieve load balancing between servers, and servers with a higher load rate can affect the communication efficiency of real-time communication.

### SUMMARY

Embodiments of the present disclosure provide a load processing method, a load processing apparatus, an electronic device and a storage medium.

According to a first aspect of the present disclosure, a load processing method is provided, the load processing method comprises:
obtaining a current load rate of a target server;
in response to that the load rate is greater than a first threshold, performing a de-accessing processing on an accessing party accessed to the target server, and in response to that the load rate is not greater than the first threshold, stopping the de-accessing, wherein the de-accessing processing is used to reduce a volume of the accessing party accessed to the target server.

According to a second aspect of the present disclosure, a load processing apparatus is provided, the load processing apparatus comprises:
a load rate obtaining module, configured to obtain a current load rate of a target server;
a de-accessing module, configured to, in response to that the load rate is greater than a first threshold, performing a de-accessing processing on an accessing party accessed to the target server, and in response to that the load rate is not greater than the first threshold, stop the de-accessing processing, wherein the de-accessing processing is used to reduce a volume of the accessing party accessed to the target server.

According to a third aspect of the present disclosure, an electronic device is provided. The electronic device comprises: a memory and a processor, the memory stores computer instructions, upon the computer instructions being executed by the processor, the above-mentioned method is implemented.

According to a fourth aspect of the present disclosure, a computer-readable storage medium which stores computer instructions is provided, upon the computer instructions being executed by a processor, the above-mentioned method is implemented.

According to the load processing method, the load processing apparatus, the electronic device and the storage medium provided by the embodiments of the present disclosure, a current load rate of a target server is obtained, in response to that the load rate is greater than a first threshold, a de-accessing processing is performed on an accessing party accessed to the target server, and in response to that the load rate is not greater than the first threshold, the de-accessing is stopped; the de-accessing processing is used to reduce a volume of the accessing party accessed to the target server. In this way, by obtaining the load rate of the running target server and de-accessing the accessing parties in response to that the load rate is excessively high, overload of the target server can be dealt with timely, improving the user experience of accessing the target server.

### BRIEF DESCRIPTION OF DRAWINGS

Further details, features and advantages of the present disclosure are disclosed below with reference to the description of the exemplary embodiments in the accompanying drawings, in which:

FIG. 1 is a flow chart of unloading processes provided in an exemplary embodiment of the present disclosure;

FIG. 2 is a flow chart of a load processing method provided in an exemplary embodiment of the present disclosure;

FIG. 3 is a schematic block diagram of a functional module of a load processing apparatus provided in an exemplary embodiment of the present disclosure;

FIG. 4 is a structural block diagram of an electronic device provided in an exemplary embodiment of the present disclosure; and

FIG. 5 is a structural block diagram of a computer system provided in an exemplary embodiment of the present disclosure.

### DETAILED DESCRIPTION

The embodiments of the present disclosure are described in more detail below with reference to the accompanying drawings. Although some embodiments of the present disclosure are shown in the drawings, it should be understood that the present disclosure may be realized in various forms and should not be construed as limited to the embodiments set forth herein, but rather provided for a more thorough and complete understanding of the present disclosure. It should be understood that the drawings and embodiments of the present disclosure are for illustrative purposes only and are not intended to limit the patentable scope of the present disclosure.

It should be understood that the steps described in the method implementations of the present disclosure may be implemented in different sequences and/or in parallel. In addition, the method implementations may include additional steps and/or omit the steps shown. The scope of the present disclosure is not limited in this regard.

The term “including” and the variations thereof used herein are inclusive, meaning “including but not limited to”. The term “based on” means “at least partially based on”. The term “one embodiment” means “at least one embodiment”. The term “another embodiment” means “at least one additional embodiment”. The term “some embodiments” means “at least some embodiments”. The relevant definitions of other terms are given in the following descriptions. It should be noted that concepts such as “first” and “second” in the present disclosure are only used to distinguish different apparatuses, modules or units, and are not used to define the order or interdependence of the functions performed by these apparatuses, modules or units.

It should be noted that the modifications of “one” and “many” in the present disclosure are indicative and not restrictive, and those skilled in the art should understand that they should be understood as “one or more” unless the context expressly indicates otherwise.

The names of messages or information exchanged between multiple apparatuses in the implementations of the present disclosure are for illustrative purposes only and are not intended to limit the scope of such messages or information.

It should be understood that before using the technical solutions disclosed in the embodiments of the present disclosure, the type, scope of use, use scenarios, and the like of personal information involved in the present disclosure must be informed to users and authorization must be obtained from the users through appropriate methods in accordance with relevant laws and regulations.

For example, in response to receiving an active request from a user, prompt information is sent to the user to explicitly inform the user that acquisition and use of personal information of the user are required to perform the action requested. In this way, the user may choose whether to provide personal information to software or hardware such as an electronic device, an application, a server, or a storage medium that performs operations of the technical solution of the present disclosure according to the prompt information.

As an optional but non-limiting implementation, in response to receiving an active request from a user, prompt information is sent to the user by means such as a pop-up window, where the pop-up window may present the prompt information in the form of text. In addition, the pop-up window may also carry a selection control for the user to choose whether to Agree or Disagree to provide personal information to the electronic device. It should be understood that the foregoing notification and the process of obtaining user authorization are only illustrative and do not limit the implementations of the present disclosure, and other means that meet the relevant laws and regulations may also be applied in the implementations of the present disclosure.

In the embodiments provided in the present disclosure, in order to avoid affecting efficiency of real-time communication by an overloading server, the overloading server needs to be processed to reduce the load rate of the server.

Therefore, in the embodiments, a load state of a server may be classified according to the loading conditions of the server. For example, load states of the server are classified into a normal state, an alarming state, and a hazardous state based on the load rate of the server. The load rate of a server may also be measured by water levels. For example, the load state of a server is classified into three water levels, such as a normal water level, a warning water level and a hazardous water level, and the embodiments are not limited to this case.

In an embodiment, in response to that the load of a server is in the normal state, users may be allowed to perform operations such as accessing to the server and entering a room, pushing streams, or pulling streams.

Specifically, the load of a server is determined to be in the normal state when the load rate of the server is less than a certain threshold. For example, when the load rate of a server is less than 75%, the load of the server is in the normal state, that is, the water level corresponding to the load is in the normal level. In this case, the server is still capable of accessing new users and can run the access of new users. Specifically, in scenarios such as live streaming, users may also be allowed to pull or push streams. The stream pulling operation refers to obtaining a video stream from a server, such as watching a video stream obtained from a server on a terminal. The stream pushing operation refers to sending a video stream to a server, for example, shooting a video on a terminal and sending the video to the server by a user.

When the load of a server is in the warning state, the server is already in the full load state, and access of new users may be rejected to avoid further increase of the load on the server.

Specifically, the load of a server is determined to be in the warning state when the load rate of the server is in a certain range. For example, when the load rate of a server is in the range of 75% to 90%, the server is determined to be in the warning state. That is, the water level corresponding to the load is at the warning water level. In order to avoid overloading a server, accesses of new users may be rejected, ensuring data processing efficiency of the server, and avoiding communication delays caused by excessive load on the server.

When the load of a server is in the hazardous state, the server is overloaded and the relevant users need to be kicked off to reduce the load rate of the server.

Specifically, the load of a server is determined to be in the hazardous state when the load rate of the server is in a certain range. For example, when the load rate of a server is in the range of 90% to 100%, the server is determined to be in the hazardous state. That is, the water level corresponding to the load is at the hazardous water level. In this case, the server is seriously overloaded, and in order to reduce the load rate of the server, accesses of new users need to be rejected and some users who have already accessed need to be kicked off.

In the embodiments, when some users who have already accessed are kicked off, impact on some key users is minimized while the load rate of the server is reduced. In the embodiments, users accessed to a server may be classified to obtain a plurality of categories of accessed users, and the users may be de-accessed according to the categories of the accessed users.

Specifically, in an embodiment, for example, in a video conference scenario or a live streaming scenario, accessed users may be classified based on the streaming pushing information, stream pulling information, role information, or subscription information thereof. For example, users may be classified into four category: silent users, stream pushing-only users, stream pulling-only users, and stream pushing and stream pulling users.

A silent user refers to a user that only pulls streams but does not push streams, and send no notification to any user in the room. For example, a silent user does not notify any users in the room, only gets a video stream, and does not post any video stream.

A stream pushing-only user refers to a user who enters a room and only pushes streams, does not pull streams, and has no subscription to the pushed streams. For example, a stream pushing-only user only posts a video stream, but the posted video stream is not watched by other users in the room.

A stream pulling-only user refers to a user who enters a room and only pulls streams and does not push streams. For example, a stream pulling-only user only obtains a video stream in a room to watch and does not post video streams.

A stream pushing and stream pulling user refers to a user who enters a room, and both pushes and pulls streams. For example, a stream pushing and stream pulling user may both get a video stream in a room to watch and post a video stream.

In the embodiments, the priority of the accessed users may be set according to the categories of the accessed users. For example, the users are de-accessed according to the following priority order: stream pushing-only users, silent users, stream pulling-only users, and stream pushing and stream pulling users.

In this way, when the load of a server reaches the hazardous state, the accessed users may be de-accessed according to the above-mentioned de-accessing priority, and the de-accessing process is used to reduce the volume of the users who access to the server.

For example, users who only push streams that are not subscribed by any users need to be kicked off first. In other words, the de-accessing processing is performed on the stream pushing-only users in the accessed users. Because the stream pushing-only users only post video streams, but the posted video streams are not subscribed by other users, the stream pushing-only users may be kicked off first without affecting other users.

After that, silent users are kicked off. Because silent users do not interact with other users in the room, only obtain video streams and do not post video streams, de-accessing processing of the silent users does not affect other users.

Then, the stream pulling-only users are kicked off. That is, users who only pull streams but do not push streams are de-accessed. Because the stream pulling-only users do not post video streams, de-accessing processing of such users does not have much impact on other users.

Finally, pull-push users are kicked off. This ensures that the water level of the server is lowered quickly, while ensuring the user experience as much as possible.

In an embodiment, when the users accessed to a server are de-accessed, a certain proportion of users may be kicked off at an interval to avoid kicking all of the users off at one time. For example, 10% of the users are kicked off every 10 seconds, and then the load state of the server is detected.

Therefore, based on the above embodiments, classifying the load state of a server into the normal state, the warning state and the hazardous state in the above embodiments allows for processing of the user accesses by detecting the state of the load of the server.

Therefore, in the embodiments provided in the present disclosure, as shown in FIG. 1, in step S11, whether the load state of a server is in the normal state is detected, and if the load of the server is in the normal state, in step S12, a new user may be allowed to access. That is, in response to that the load state of the server is in the normal state, when a new user requests to access, the access of the new user can be run. Instead, in response to that the load state of the server is detected as not in the normal state, in step S13, whether the load state of the server is in the warning state is detected. When the load state of the server is currently in the warning state, it means that the server is currently running at full load, and allowing the access of new users may lead to overload of the server. Therefore, in response to that the load of the server is in the warning state, in step S14, an access of a new user is rejected, and in step S17, the load state of the server may be detected again after a preset time interval. In this way, suspending for a preset time interval and then detecting the load again may generate more accurate detection result.

In response to that the load state of the server is detected as not in the warning state, in step S15, the server may be determined to be in the hazardous state, and then step S16 needs to be executed, where the de-accessing processing is performed on the accessed users on the server, and after the de-accessing processing, the load state of the server is detected again after a preset time interval, such that the server is in a relatively stable state after a period of time after the de-accessing, obtaining more accurate detection result. In the embodiments, the preset time interval may be set as needed, for example, 10 s, and the embodiments are not limited thereto.

In the embodiments, when the accessed users on the server are de-accessed, the corresponding category of users are kicked off in turn according to the priority obtained through the above means. For example, 10% of the users may be kicked each time, and the stream pushing-only users are first de-accessed. If the number of stream pushing-only users is less than 10%, the silent users are then de-accessed, and if the sum of the silent users and the stream pushing-only users is not more than 10%, the stream pulling-only users are then de-accessed, and if still less than 10% of the users are de-accessed, the stream pushing and stream pulling users are then de-accessed until 10% of the users is are de-accessed. This allows to continue to detect the current load state of the server after a preset time interval.

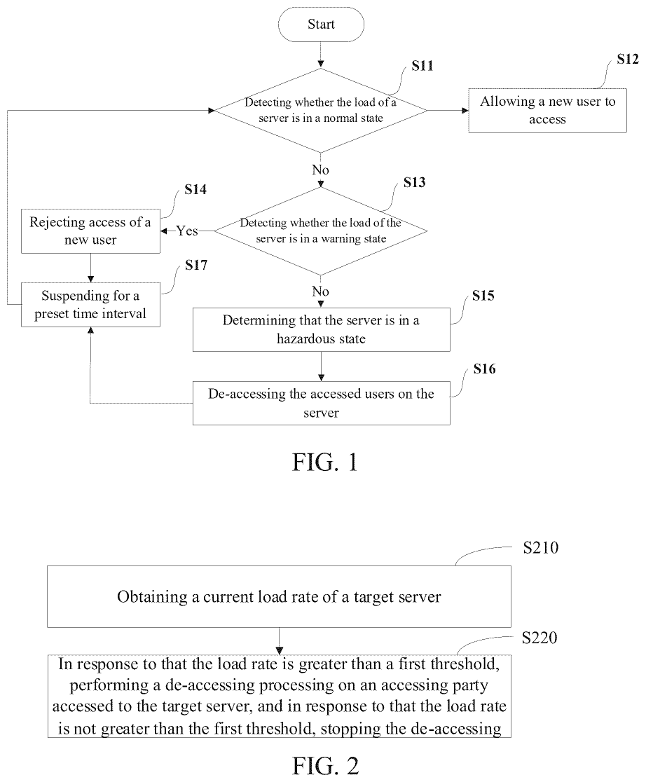

Based on the above embodiment, in another embodiment provided in the present disclosure, as shown in FIG. 2, the embodiments of the present disclosure also provide a load processing method, which may include the following steps.

In step S210, the current load rate of a target server is obtained.

In the embodiments, the target server may be a server in the above embodiments, and specifically, the target server may be a streaming media server, a media server, or an edge server, or the like, and the embodiments are not limited thereto.

In step S220, when the load rate is greater than a first threshold, the de-accessing processing is performed on an accessing party to the target server, and the de-accessing processing is stopped when the load rate is not greater than the first threshold.

The de-accessing processing in the embodiments is used to reduce the volume of accessing party accessed to the target server. For example, some accessing party are removed or kicked off, where the accessing party may be a user or a terminal.

In the embodiments, the load rate of a server may be detected, and in response to that the load rate of the server is greater than the first threshold, de-accessing processing may be performed on users accessed to the server. For example, the first threshold may be a dividing line between the hazardous state and the warning state in the above embodiments, that is, a critical point at which the server enters the hazardous state. When the load rate of the server is greater than the first threshold, which means that the load rate of the server is already in the hazardous state, the de-accessing processing is required.

In the load processing method provided in the embodiments of the present disclosure, the current load rate of the target server is obtained, and the de-accessing processing is performed on the accessing party accessed to the target server when the load rate is greater than the first threshold, and the de-accessing processing is stopped in response to that the load rate is not greater than the first threshold. This de-accessing processing is used to reduce the volume of the accessing party accessed to the target server. In this way, by obtaining the load rate of the running target server and de-accessing the accessing party in response to that the load rate is high, overload of the target server may be dealt with timely, improving the user experience of accessing the target server.

Based on the above embodiments, in the embodiments provided in the present disclosure, when the accessing party accessed to the server are de-accessed, the accessing party may be classified and de-accessed based on the category obtained. Therefore, in the embodiments, the category of the accessing party accessed to the target server are obtained, and the accessing party are de-accessed based on the category. Based on the above embodiment, de-accessing priority may be set based on the category of accessing party, and starting from those with a higher priority, the accessing party may be de-accessed until the load rate of the server is not greater than the first threshold.

It should be noted that in the embodiments, the push-pull stream information may be obtained from the accessing party accessed to the target server and the category of the accessing party may be determined based on the push-pull stream information. For example, according to the above embodiment, the accessing party may be specifically classified into the four category of users, and the four category may be de-accessed in turn based on the de-accessing priority thereof. The push-pull stream information includes at least one selected from a group consisting of stream pulling information, streaming pushing information, and subscription information.

In this embodiment, when the accessing party are de-accessed, priority of the accessing party are obtained based on the category of the accessing party. Based on the priority, the accessing party are periodically de-accessed. A certain proportion of the accessing party are de-accessed in each period. For example, a target proportion of the accessing party may be de-accessed. For example, a de-accessing period may be set, and the load state of the server may be detected once in each period. In response to that the load rate of the server is greater than the first threshold, that is, in the hazardous state, the accessing party of the server are de-accessed, and a target proportion may be set for each de-accessing, for example, 10% of the accessing party may be de-accessed in each period, but the embodiments are not limited thereto.

In the embodiments provided in the present disclosure, when the load rate of the server is greater than a second threshold and not greater than the first threshold, a new accessing party may be prohibited from accessing the target server. The second threshold is less than the first threshold.

When the load rate of the server is greater than the second threshold and not greater than the first threshold, the load rate of the server is in the warning state described above, and access from a new accessing party may be prohibited to avoid further increase of the load rate of the server.

In response to that the load rate is greater than a third threshold and less than the second threshold, a new accessing party is allowed to access the target server. The third threshold is less than the second threshold.

In the embodiments, when the load rate of the server is greater than the third threshold and less than the second threshold, the load state of the server is in the normal state and the access of a new accessing party can be run. The first threshold may be 90%, the second threshold may be 75%, the third threshold may be 0. The first threshold, the second threshold, and the third threshold in the embodiments may be set as needed, and the embodiments are not limited thereto.

Based on the above embodiments, in the embodiments provided in the present disclosure, a timing may also be started in response to the completion of the de-accessing processing of the accessing party detecting being detected. In response to that the obtained duration reaches a target duration, the timing is stopped, and the next period starts and the current load rate of the target server is re-obtained. For example, when the users accessed to a server are de-accessed, a certain proportion of users may be kicked off at an interval to avoid kicking all of the users off at one time. For example, 10% of the users are kicked off every 10 seconds, and then the load state of the server is detected.

In the embodiments, after each de-accessing processing of the accessing party is completed, the load rate of the server may be detected again after a period of time, ensuring that the server is in a stable state when the load rate of the server is detected, and avoiding detecting the load rate of the server again immediately after the de-accessing, which prevents from obtaining accurate current load rate of the server.

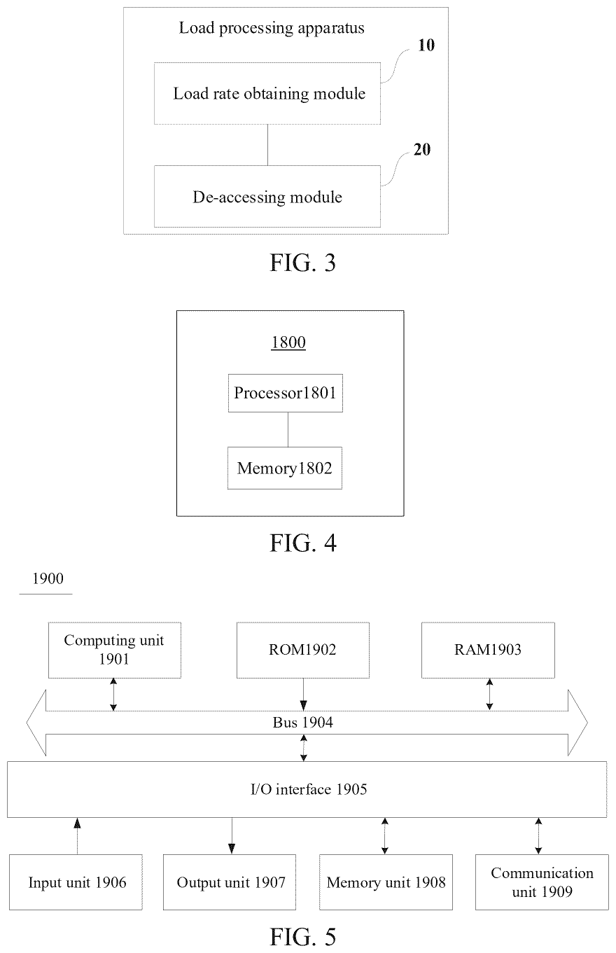

In the case that the functional modules are divided by corresponding functions, the embodiments of the present disclosure provide a load processing apparatus, which may be a server, a terminal or a chip applied to a server. FIG. 3 is a schematic block diagram of a functional module of a load processing apparatus provided in an exemplary embodiment of the present disclosure. As shown in FIG. 3, the load processing apparatus includes:
a load rate obtaining module 10, configured to obtain a current load rate of a target server; and
a de-accessing module 20, configured to, in response to that the load rate is greater than a first threshold, perform a de-accessing processing on an accessing party accessed to the target server, and in response to that the load rate is not greater than the first threshold, stop the de-accessing processing; the de-accessing processing is used to reduce a volume of the accessing party accessed to the target server.

In another embodiment provided by the present disclosure, the de-accessing module is specifically configured to
obtain a category of the accessing party to the target server; and
perform the de-accessing processing on the accessing party based on the category.

In another embodiment provided by the present disclosure, the de-accessing module is further specifically configured to
obtain push-pull stream information of the accessing party accessed to the target server, and determine the category of the accessing party based on the push-pull stream information.

In another embodiment provided by the present disclosure, the push-pull stream information comprises at least one selected from a group consisting of stream pulling information, streaming pushing information, and subscription information.

In another embodiment provided by the present disclosure, the de-accessing module is further specifically configured to
obtain a priority of the accessing party based on the category of the accessing party; and
based on the priority, perform the de-accessing processing on the accessing party periodically; a target proportion of the accessing party are de-accessed in each period.

In another embodiment provided by the present disclosure, the load processing apparatus further includes:
a timing module, configured to start timing in response to detecting completion of the de-accessing processing of the accessing party; and
a duration obtaining module, configured to, in response to that an obtained duration of the timing reaches a target duration, stop the timing.

In another embodiment provided by the present disclosure, the load processing apparatus further includes:
access forbidden module, configured to, in response to that the load rate is greater than a second threshold and not greater than the first threshold, forbid a new accessing party to access the target server; the second threshold is less than the first threshold.

In another embodiment provided by the present disclosure, the load processing apparatus further includes:
access module, configured to, in response to that the load rate is greater than a third threshold and less than the second threshold, allow a new accessing party to access the target server; the third threshold is less than the second threshold.

For the part of the apparatus, corresponding to the above method, please refer to the description of the corresponding embodiments of the method for details, which will not be repeated here.

According to the load processing apparatus provided by the embodiments of the present disclosure, a current load rate of a target server is obtained, in response to that the load rate is greater than a first threshold, a de-accessing processing is performed on an accessing party accessed to the target server, and in response to that the load rate is not greater than the first threshold, the de-accessing is stopped; the de-accessing processing is used to reduce a volume of the accessing party accessed to the target server. In this way, by obtaining the load rate of the running target server and de-accessing the accessing parties in response to that the load rate is excessively high, overload of the target server can be dealt with timely, improving the user experience of accessing the target server.

Embodiments of the present disclosure further provides an electronic device, the electronic device comprises: a memory and a processor, the memory is configured to store computer instructions executable by the processor, the processor is configured to execute the computer instructions, the above-mentioned method is implemented.

FIG. 4 is a structural schematic diagram of an electronic device provided in an exemplary embodiment of the present disclosure. As shown in FIG. 4, the electronic device 1800 includes at least one processor 1801 and a memory 1802 coupled to the processor 1801, where the processor 1801 may perform the corresponding steps in the method disclosed in the embodiments of the present disclosure.

The processor 1801 may also be referred to as a central processing unit (CPU), which may be an integrated circuit chip with signal processing capability. Each step in the method disclosed in the embodiments of the present disclosure may be implemented by an integrated logic circuit of hardware or an instruction in the form of software in the processor 1801. The processor 1801 may be a general-purpose processor, a digital signal processor (DSP), an application specific integrated circuit (ASIC), a field-programmable gate array (FPGA) or other programmable logic devices, a discrete gate or transistor logic device, or a discrete hardware component. A general-purpose processor may be a microprocessor, or the processor may be any regular processor, or the like. The steps in conjunction with the method disclosed in the embodiments of the present disclosure may be directly executed and completed in a hardware decoding processor, or may be executed and completed by the combination of hardware and software modules in a decoding processor. The software module may be located in a memory 1802, such as a random memory, a flash memory, a read-only memory, a programmable read-only memory or an electrically rewritable programmable memory, a register, and other mature storage media in the art. The processor 1801 reads information in the memory 1802 and completes the steps of the method in combination with the hardware thereof.

In addition, when various operations/processes according to the present disclosure may be implemented through software and/or firmware, a program constituting the software may be installed from a storage medium or network to a computer system with a dedicated hardware structure, such as a computer system 1900 shown in FIG. 5, which, when installed with various programs, is capable of performing various functions, including functions such as those described above, and so on. FIG. 5 is a structural schematic diagram of a computer system provided in an exemplary embodiment of the present disclosure.

The computer system 1900 is intended to refer to various forms of digital electronic computer devices, such as a laptop computer, a desktop computer, a workbench, a personal digital assistant, a server, a blade server, a mainframe computer, and other appropriate computers. The electronic device may also refer to various forms of mobile devices, such as a personal digital assistant, a cellular phone, a smart phone, a wearable device, and other similar computing devices. The components shown herein, the connections and relationships thereof, and the functionalities thereof are for illustrative only and are not intended to limit the implementation of the present disclosure described and/or required herein.

As shown in FIG. 5, the computer system 1900 includes a computing unit 1901 that can perform various appropriate actions and processes according to a computer program stored in a read-only memory (ROM) 1902 or loaded from the memory unit 1908 into a random access memory (RAM) 1903. Various programs and data required for the operation of the computer system 1900 are also stored in the RAM 1903. The computing unit 1901, the ROM 1902 and the RAM 1903 are connected to each other through a bus 1904. An input/output (I/O) interface 1905 is also connected to the bus 1904.

A number of components in the computer system 1900 are connected to the I/O interface 1905, including: an input unit 1906, an output unit 1907, a memory unit 1908, and a communication unit 1909. The input unit 1906 may be any type of device capable of inputting information into the computer system 1900, and the input unit 1906 may receive the input numeric or character information and generate a key signal input related to user settings and/or functional control of the electronic device. The output unit 1907 may be any type of device capable of presenting information, and may include, but is not limited to, a monitor, a speaker, a video/audio output terminal, a vibrator, and/or a printer. The memory unit 1908 may include, but is not limited to, a disk and an optical disc. The communication unit 1909 allows the computer systems 1900 to exchange information/data with other devices over a network such as the Internet, and may include, but is not limited to, a modem, a network card, an infrared communication device, a wireless communication transceiver, and/or a chipset, such as a Bluetooth™ device, a Wi-Fi device, a WiMax device, a cellular communication device, and/or the like.

The computing unit 1901 may be a variety of general-purpose and/or specialized processing components with processing and computing capabilities. Some examples of the computing unit 1901 include, but are not limited to, a central processing unit (CPU), a graphics processing unit (GPU), various specialized artificial intelligence (AI) computing chips, various computing units running machine learning model algorithms, a digital signal processor (DSP), and any appropriate processors, controllers, microcontrollers, or the like. The computing unit 1901 performs the methods and processes described above. For example, in some embodiments, the method disclosed in the embodiments of the present disclosure may be implemented as a computer software program that is tangibly contained in a machine-readable medium, such as a memory unit 1908. In some embodiments, part or all of the computer program may be loaded and/or installed onto the electronic device via the ROM 1902 and/or the communication unit 1909. In some embodiments, the computing unit 1901 may be configured to perform the above methods disclosed in the embodiments of present disclosure by any other appropriate means (for example, by firmware).

The embodiments of the present disclosure also provide a computer-readable storage medium, where the instructions in the computer-readable storage medium, when being executed by the processor of the electronic device, enable the electronic device to perform the methods disclosed in the embodiments of the present disclosure.

A computer-readable storage medium in the embodiments of the present disclosure may be a tangible medium containing or storing a program to be used by an execution system, apparatus or device or in combination with an instruction. Such computer-readable storage medium may include, but is not limited to, an electronic, magnetic, optical, electromagnetic, infrared, or semiconductor system, apparatus, or device, or any appropriate combination thereof. More specifically, the computer-readable storage medium may include electrical connections based on one or more wires, a portable computer drive, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The computer-readable medium described above may be contained in the electronic device described above. It may also exist on its own and not be integrated into the electronic device.

The embodiments of the present disclosure also provide a computer program product, including a computer program, where the computer program, when being executed by a processor, implement the method disclosed in the embodiments of the present disclosure.

In the embodiments of the present disclosure, computer program codes for performing the operations of the present disclosure may be written in one or more programming languages, or a combination thereof, including, but not limited to, an object-oriented programming language, such as Java, Smalltalk, C++, and may also include a conventional procedural programming language, such as the “C” language or a similar programming language. The program codes may be executed entirely on a user computer, partially on a user computer, as a stand-alone software package, partly on a user computer and partly on a remote computer, or entirely on a remote computer or server. When a remote computer is involved, the remote computer may be connected to the user computer through any network, including a local area network (LAN) or wide area network (WAN), or may be connected to an external computer.

The flowcharts and block diagrams in the accompanying drawings illustrate the architecture, functions, and operations that may be implemented in accordance with the systems, methods, and computer program products in the various embodiments of the present disclosure. In this regard, each box in a flowchart or block diagram may represent a module, a program segment, or a part of codes that contain one or more executable instructions for implementing a specified logical function. It should also be noted that in some implementations as an alternative, the functions indicated in the boxes may also occur in a different order than those indicated in the drawings. For example, two successive boxes may actually be executed in essentially parallel order, and they can sometimes be executed in a reverse order, depending on the function involved. It should also be noted that each box in the block diagram and/or flowchart, and a combination of the boxes in the block diagram and/or flowchart, may be implemented with a dedicated hardware-based system that performs a defined function or operation, or with a combination of dedicated hardware and computer instructions.

The module, component or unit described in the embodiments of the present disclosure may be implemented by means of software or by means of hardware. The name of a module, a part or a unit does not in any case limit the module, the part or the unit itself.

The functions described above herein may be performed at least in part by one or more hardware logic components. As a non-limiting example, hardware logic components that can be used include: a field-programmable gate array (FPGA), an application-specific integrated circuit (ASIC), an application-specific standard product (ASSP), a system-on-chip (SOC), a complex programmable logic device (CPLD), and the like.

The above only describes some embodiments of the present disclosure and the technical principles used. Those skilled in the art may understand that the scope of disclosure involved in the present disclosure is not limited to the technical solutions formed by the specific combination of the above-mentioned technical features, but should also cover other technical solutions formed by any combination of the above-mentioned technical features or their equivalent features without departing from the above-mentioned disclosure concept. For example, a technical solution formed by replacing the above-mentioned features with (but not limited to) technical features with similar functions disclosed in the present disclosure.

Although some specific embodiments of the present disclosure have been described in detail by examples, those skilled in the art should understand that the above examples are for illustrative purposes only and are not intended to limit the scope of the present disclosure. Those skilled in the art should understand that the above embodiments may be modified without departing from the scope and spirit of the present disclosure. The scope of the present disclosure is limited by the claims.

1. A load processing method, comprising:
obtaining a current load rate of a target server;
in response to that the load rate is greater than a first threshold, performing a de-accessing processing on an accessing party accessed to the target server, and in response to that the load rate is not greater than the first threshold, stopping the de-accessing, wherein the de-accessing processing is used to reduce a volume of the accessing party accessed to the target server.

2. The method according to claim 1, wherein performing the de-accessing processing on the accessing party accessed to the target server comprises:
obtaining a category of the accessing party to the target server; and
performing the de-accessing processing on the accessing party based on the category.

3. The method according to claim 2, wherein obtaining the category of the accessing party to the target server comprises:
obtaining push-pull stream information of the accessing party accessed to the target server, and determining the category of the accessing party based on the push-pull stream information.

4. The method according to claim 3, wherein the push-pull stream information comprises at least one selected from a group consisting of stream pulling information, streaming pushing information, and subscription information.

5. The method according to claim 2, wherein performing the de-accessing processing on the accessing party based on the category comprises:
obtaining a priority of the accessing party based on the category of the accessing party; and
based on the priority, performing the de-accessing processing on the accessing party periodically, wherein a target proportion of the accessing party are de-accessed in each period.

6. The method according to claim 1, further comprising:
starting timing in response to detecting completion of the de-accessing processing of the accessing party; and
in response to that an obtained duration of the timing reaches a target duration, stopping the timing, and executing the step of obtaining the current load rate of the target server.

7. The method according to claim 1, further comprising:
in response to that the load rate is greater than a second threshold and not greater than the first threshold, forbidding a new accessing party to access the target server, wherein the second threshold is less than the first threshold.

8. The method according to claim 7, further comprising:
in response to that the load rate is greater than a third threshold and less than the second threshold, allowing a new accessing party to access the target server, wherein the third threshold is less than the second threshold.

9. An electronic device, comprising:
at least one processor;
a memory configured to store executable instructions of the at least one processor,
wherein the at least processor is configured to execute the instructions to implement a load processing method;
the load processing method comprises:
obtaining a current load rate of a target server;
in response to that the load rate is greater than a first threshold, performing a de-accessing processing on an accessing party accessed to the target server, and in response to that the load rate is not greater than the first threshold, stopping the de-accessing, wherein the de-accessing processing is used to reduce a volume of the accessing party accessed to the target server.

10. A computer-readable storage medium with instructions, upon the instructions in the computer-readable storage medium being executed by a processor of an electronic device, the electronic device is enabled to perform a load processing method, wherein the load processing method comprises:
obtaining a current load rate of a target server;
in response to that the load rate is greater than a first threshold, performing a de-accessing processing on an accessing party accessed to the target server, and in response to that the load rate is not greater than the first threshold, stopping the de-accessing, wherein the de-accessing processing is used to reduce a volume of the accessing party accessed to the target server.

11. The method according to claim 1, wherein a load state of a server is classified according to loading conditions of the server;
load states of the server are classified into a normal state, an alarming state, and a hazardous state based on the current load rate of the server.

12. The method according to claim 11, wherein performing the de-accessing processing comprises kicking off a certain proportion of users at an interval; and
detecting the load state of the server after each de-accessing processing of the accessing party is completed.

13. The method according to claim 11, comprising:
detecting whether the load state of the server is in the normal state, wherein
in response to that the load state of the server is in the normal state, a new user is allowed to access,
in response to that the load state of the server is detected as not in the normal state, whether the load state of the server is in the warning state is detected,
in response to that the load of the server is in the warning state, an access of a new user is rejected, and the load state of the server is detected again after a preset time interval,
in response to that the load state of the server is detected as not in the warning state, the server is determined to be in the hazardous state, and then the de-accessing processing is performed on the accessing party accessed to the server, and after the de-accessing processing, the load state of the server is detected again after a preset time interval.

14. The method according to claim 4, wherein the accessing party is classified into following four categories: silent users, stream pushing-only users, stream pulling-only users, and stream pushing and stream pulling users.

15. The method according to claim 5, wherein the accessing party is de-accessed according to a following priority order: the stream pushing-only users, the silent users, the stream pulling-only users, and the stream pushing and stream pulling users.

16. The electronic device according to claim 9, wherein a load state of a server is classified according to loading conditions of the server;
load states of the server are classified into a normal state, an alarming state, and a hazardous state based on the current load rate of the server.

17. The electronic device according to claim 16, wherein performing the de-accessing processing comprises kicking off a certain proportion of users at an interval; and
detecting the load state of the server after each de-accessing processing of the accessing party is completed.

18. The electronic device according to claim 16, comprising:
detecting whether the load state of the server is in the normal state, wherein
in response to that the load state of the server is in the normal state, a new user is allowed to access,
in response to that the load state of the server is detected as not in the normal state, whether the load state of the server is in the warning state is detected,
in response to that the load of the server is in the warning state, an access of a new user is rejected, and the load state of the server is detected again after a preset time interval,
in response to that the load state of the server is detected as not in the warning state, the server is determined to be in the hazardous state, and then the de-accessing processing is performed on the accessing party accessed to the server, and after the de-accessing processing, the load state of the server is detected again after a preset time interval.

19. The method according to claim 9, wherein performing the de-accessing processing on the accessing party accessed to the target server comprises:
obtaining a category of the accessing party to the target server; and
performing the de-accessing processing on the accessing party based on the category;
obtaining the category of the accessing party to the target server comprises:
obtaining push-pull stream information of the accessing party accessed to the target server, and determining the category of the accessing party based on the push-pull stream information;
the push-pull stream information comprises at least one selected from a group consisting of stream pulling information, streaming pushing information, and subscription information;
the accessing party is classified into following four categories: silent users, stream pushing-only users, stream pulling-only users, and stream pushing and stream pulling users.

20. The method according to claim 9, wherein performing the de-accessing processing on the accessing party accessed to the target server comprises:
obtaining a category of the accessing party to the target server; and
performing the de-accessing processing on the accessing party based on the category;
performing the de-accessing processing on the accessing party based on the category comprises:
obtaining a priority of the accessing party based on the category of the accessing party; and
based on the priority, performing the de-accessing processing on the accessing party periodically, wherein a target proportion of the accessing party are de-accessed in each period;
the accessing party is de-accessed according to a following priority order: the stream pushing-only users, the silent users, the stream pulling-only users, and the stream pushing and stream pulling users.
